(19) United States
(12) Patent Application Publication
(10) Pub. No.: US 2024/0161143 A1
(43) Pub. Date: May 16, 2024

(54) INFORMATION PROCESSING APPARATUS AND INFORMATION PROCESSING METHOD

(71) Applicant: Toshiba Tec Kabushiki Kaisha, Tokyo (JP)

(72) Inventor: Takahiro YASUDA, Mishima Shizuoka (JP)

(21) Appl. No.: 18/467,078

(22) Filed: Sep. 14, 2023

(30) Foreign Application Priority Data
Nov. 16, 2022 (JP) 2022-183314

(51) Int. Cl. G06Q 30/0207; G06Q 30/0238

(52) U.S. Cl. CPC G06Q 30/0215; G06Q 30/0213; G06Q 30/0238

(57) ABSTRACT

According to an embodiment, an information processing apparatus acquires transaction information including a point and a change amount, the point having monetary value and being given to a customer who has purchased a product in one transaction. The information processing apparatus converts the change amount into the point having the same monetary value as the change amount. Further, the point included in the transaction information and the converted point are added up and held points of the customer are managed for each customer.

### CROSS-REFERENCE TO RELATED APPLICATIONS

This application is based upon and claims the benefit of priority from the prior Japanese Patent Application No. 2022-183314, filed on Nov. 16, 2022, the entire contents of which are incorporated herein by reference.

### FIELD

An embodiment to be described here generally relates to an information processing apparatus and an information processing method.

### BACKGROUND

In the past, a system that leaves, in a store that sells a product and a service (hereinafter, referred to collectively as a “product”), the change generated in a transaction at the store has been known. This system writes the amount of change generated in the transaction as a deposit to a change card held by a customer. The customer can use the deposit stored in the change card to make purchases at subsequent transactions.

In order to increase the number of users of the change card, a system that gives a premium point to the user of the change card is proposed.

However, in this existing technology, it is necessary to separately manage the change and the point and the operation in the store has been complicated. For example, in the case where a customer uses the point and the deposit to purchase a product, it is necessary to perform processing relating to the deposit and processing relating to the point.

### BRIEF DESCRIPTION OF THE DRAWINGS

FIG. 1 is a diagram showing a management system including a point system according to an embodiment.

FIG. 2 is a block diagram showing a hardware configuration of a POS terminal according to the embodiment.

FIG. 3 is a diagram showing a data configuration of a deposit/granted point setting table stored in a storage device of the POS terminal according to the embodiment.

FIG. 4 is a block diagram showing a functional configuration of a controller of the POS terminal according to the embodiment.

FIG. 5 is a block diagram showing a hardware configuration of a server apparatus according to the embodiment.

FIG. 6 is a diagram showing a data configuration of a transaction information management table stored in a storage device of the server apparatus according to the embodiment.

FIG. 7 is a diagram showing a data configuration of a point management table stored in the storage device of the server apparatus according to the embodiment.

FIG. 8 is a block diagram showing a main functional configuration of a controller of the server apparatus according to the embodiment.

FIG. 9 is a flowchart showing account processing to be performed by the controller of the POS terminal according to the embodiment.

FIG. 10 is a flowchart showing point management processing to be performed by the controller of the server apparatus according to the embodiment.

FIG. 11 is a diagram showing a paper receipt issued by the POS terminal according to the embodiment.

FIG. 12 is a diagram showing a receipt list screen displayed by a customer terminal according to the embodiment.

### DETAILED DESCRIPTION

According to an embodiment, an information processing apparatus manages, on the basis of transaction information regarding a transaction with a customer, the point that has monetary value and is given to a customer who has purchased a product in one transaction. The information processing apparatus includes: a point management table; and a controller. The point management table stores, for each piece of identification data of a customer, held points obtained by aggregating the point given to the customer. The controller is configured to acquire, for each transaction, transaction information including the identification data of the customer and a change amount and the point generated in the one transaction. The controller is further configured to acquire a conversion point obtained by converting the change amount included in the acquired transaction information into the point having the same monetary value as the change amount. The controller is further configured to add up the point included in the acquired transaction information and the acquired conversion point. The controller is further configured to update the held points stored in the point management table by adding the added-up points to the held points corresponding to the identification data of the customer included in the acquired transaction information.

An information processing apparatus, an information processing method, and a program according to an embodiment will be described below with reference to the drawings. In the drawings, the same reference symbols denote the same or similar portions. The embodiment described below shows an information processing apparatus including a point of sales (POS) terminal serving as a payment terminal and a server apparatus. In other words, the embodiment described below shows an example in which a POS terminal and a server apparatus cooperate to realize the function of an information processing apparatus. However, the functions of the information processing apparatus may be aggregated into the POS terminal and the POS terminal may be used as the information processing apparatus. Alternatively, the functions of the information processing apparatus may be aggregated into the server apparatus and the server apparatus may be used as the information processing apparatus.

Further, although a case where a server apparatus is applied to a server apparatus that manages information of one store will be described in the embodiment described below, the present technology is not limited thereto. The server apparatus may be, for example, a server apparatus that manages information of a plurality of stores in the same company.

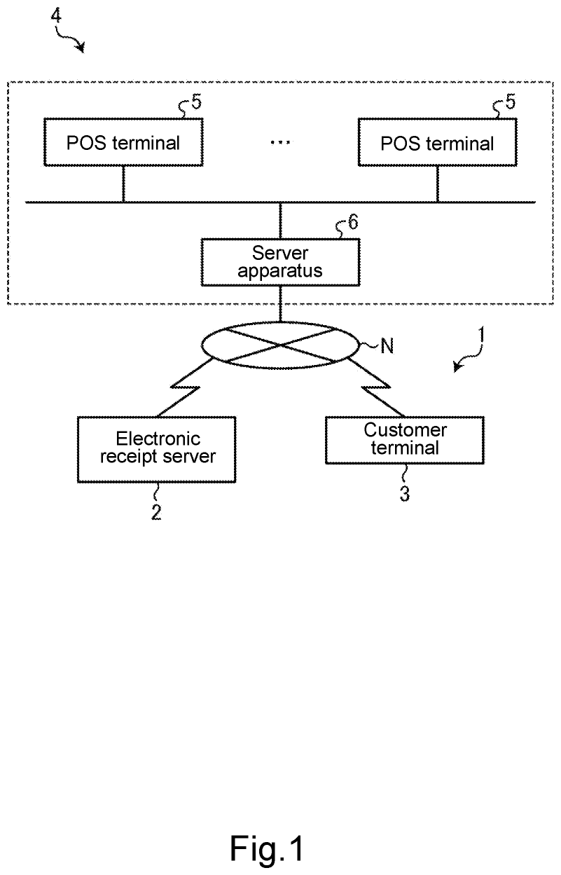

FIG. 1 is a diagram schematically showing a management system 1. The management system 1 includes an electronic receipt server 2, a customer terminal 3, and a point system 4. The electronic receipt server 2, the customer terminal 3, and the point system 4 are communicably connected to each other via a network N such as the Internet.

The electronic receipt server 2 transmits an electronic receipt to the customer terminal 3 of a member who is a customer using an electronic receipt service. The electronic receipt is obtained by converting transaction information indicating the content of one transaction to be printed on a paper receipt into electronic data. The electronic receipt server 2 acquires transaction information for each customer from the point system 4 and generates an electronic receipt.

The electronic receipt server 2 may transmit an electronic receipt to the customer terminal 3 after the transaction is finished, or may transmit an electronic receipt to the customer terminal 3 in accordance with a request from the customer terminal 3. Further, the electronic receipt server 2 transmits a receipt information list of transactions of the customer within a predetermined period to the customer terminal 3 in accordance with a request from the customer terminal 3.

The electronic receipt server 2 may be managed by a company that operates the store or another company that manages the electronic receipt service. Further, the electronic receipt server 2 may provide an electronic receipt service to a plurality of companies. Note that the point system 4 does not necessarily need to be connected to the electronic receipt server 2. In this case, the store issues a paper receipt to the customer.

The customer terminal 3 is an information terminal apparatus owned by a customer who is a member of the electronic receipt service and is, for example, a smartphone, a tablet terminal, a personal computer (PC), or the like. The customer terminal 3 receives information such as an electronic receipt and a receipt information list from the electronic receipt server 2 and displays the received information on a display device of the terminal itself. An application program for an electronic receipt service has been installed in the customer terminal 3.

The point system 4 is applied to a store such as a supermarket that sells food, clothing, daily necessities, and the like. The point system 4 includes a plurality of POS terminals 5 and a server apparatus 6. The POS terminal 5 and the server apparatus 6 are communicably connected to each other via a network such as a local area network (LAN). Further, the server apparatus 6 is communicably connected to the electronic receipt server 2 and the customer terminal 3 via the network N such as the Internet. Note that the numbers of electronic receipt servers 2, customer terminals 3, POS terminals 5, and server apparatuses 6 are not limited to the illustrated example.

The POS terminal 5 is a payment terminal that is provided in a store and executes account processing relating to payment for products to be purchased by a customer. The account processing includes processing such as product registration, payment processing, and receipt issue. The POS terminal 5 may be a POS terminal that a sales clerk performs an operation relating to product registration and account processing or may be a self-service POS terminal that the customer himself/herself performs these operations. Further, the POS terminal 5 may be a semi-self-service POS including a registration device that a sales clerk performs an operation relating to product registration and an accounting device that a customer performs an operation relating to account processing.

The POS terminal 5 sets a point to be given to a customer who is a store member (hereinafter, referred to also as a “member customer”) in one transaction. The point has monetary value and can be used for purchasing a product. Although one point has monetary value corresponding to one yen in this embodiment, the monetary value of the one point can be arbitrarily set by the store. The point given to the customer by the store includes a normal point, a deposit/granted point, and a conversion point.

In this embodiment, the normal point and the deposit/granted point are set in the POS terminal 5, and the conversion point is set in the server apparatus 6. Note that all the various types of points described above may be set in the POS terminal 5. Further, all the various types of points described above may be set in the server apparatus 6.

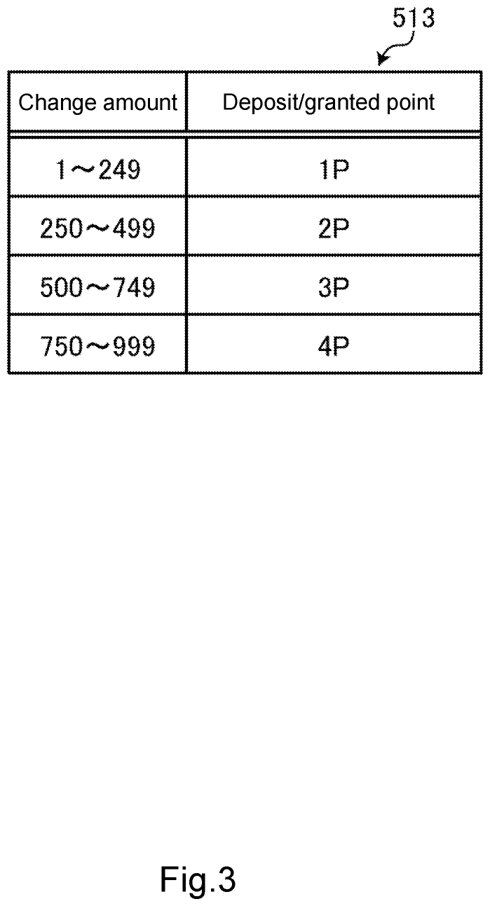

The normal point is calculated in accordance with the amount of money of products purchased by the customer. For example, the normal point is a point corresponding to the amount of money of one percent of the purchase amount of the customer. In the case where the customer does not receive the change generated in the transaction in cash, the deposit/granted point is calculated in accordance with the amount of change (hereinafter, referred to also as a “change amount”). For example, the deposit/granted point is set to 1 point in the case where the change amount is less than 250 yen, 2 point in the case where the change amount is 250 yen or more and less than 500 yen, 3 point in the case where the change amount is 500 yen or more and less than 750 yen, and 4 point in the case where the change amount is 750 yen or more and less than 1000 yen (see FIG. 3).

The conversion point is obtained by converting, in the case where the customer does not receive the change generated in the transaction in cash, the change amount into a point. For example, the conversion point is a point that is the same as the change amount, i.e., a point having the same monetary value as the change amount.

Note that the method of setting the normal point, the deposit/granted point, and the conversion point may be arbitrarily set by the store. For example, the deposit/granted point may be a point corresponding to the amount of money of 0.5% or 1% of the change amount.

In this embodiment, the customer can convert only the change amount less than 1000 yen into the conversion point without receiving the change in cash. As a result, the customer does not necessary to handle coins less than 1000 yen in one transaction, which increases convenience in shopping. Note that the amount of money that can be converted into the conversion point without receiving the change in cash by the customer may be arbitrarily set by the store to 500 yen or less, 5000 yen or less, or the like. In the following description, converting the change into the conversion point without receiving the change in cash by the customer will be referred to as “leaving the change” in some cases.

The store converts the change into the conversion point without giving the change to the customer and gives the conversion point to the customer. Thus, the customer is expected to shop in the same store from the next time on. In other words, the store is capable of retaining the customer. Further, since the store gives a deposit/granted point in the case where the customer selects to leave the change, the customer is promoted to leave the change. In other words, in order to promote the customer to leave the change, the store gives a deposit/granted point.

The POS terminal 5 issues a paper receipt for a transaction with a customer who is not a member of the electronic receipt service. Transaction information and various types of information relating to the point of the customer are printed on the paper receipt issued by the POS terminal 5.

The server apparatus 6 functions as a store server that manages various types of information of the store. For example, the server apparatus 6 receives, from each POS terminal 5, transaction information including product information of a product paid for in account processing and payment information relating to a payment method or the like. The server apparatus 6 transmits, to the electronic receipt server 2, transaction information of an electronic receipt member, of the transaction information described above.

The server apparatus 6 receives, from each POS terminal 5, sales information indicating the sales amount in a predetermined period (e.g., one day). The server apparatus 6 centrally manages the transaction information, sales information, and the like received from each POS terminal 5 and manages sales in one store. Further, the server apparatus 6 updates, as necessary, the product master storing information relating to products sold in the store and transmits the updated product master to each POS terminal 5.

The server apparatus 6 acquires the change amount in one transaction from the POS terminal 5 and converts the acquired change amount into a conversion point as necessary. Further, the server apparatus 6 manages various points given to the member customer. For example, the server apparatus 6 manages, for each transaction, the normal point, the deposit/granted point, and the conversion point given to the customer in one transaction. The normal point and the deposit/granted point are acquired from the POS terminal 5 and the conversion point is set in the server apparatus 6. Further, the server apparatus 6 manages, for each customer, held points currently held by the customer, which are points obtained by adding up the normal point, the deposit/granted point, and the conversion point.

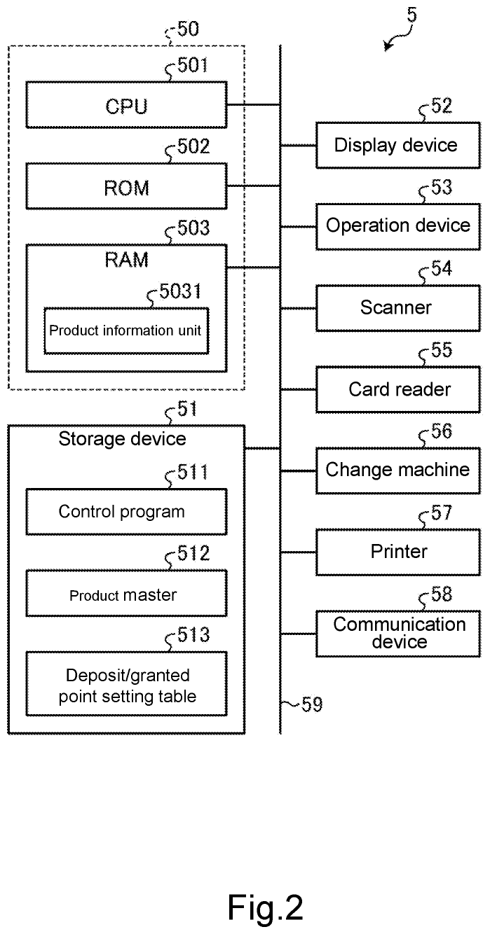

Next, the POS terminal 5 will be described in detail. FIG. 2 is a block diagram showing a main hardware configuration of the POS terminal 5. The POS terminal 5 includes a controller 50, a storage device 51, a display device 52, an operation device 53, a scanner 54, a card reader 55, a change machine 56, a printer 57, and a communication device 58. The controller 50, the storage device 51, the display device 52, the operation device 53, the scanner 54, the card reader 55, the change machine 56, the printer 57, and the communication device 58 are connected to each other via a bus 59 or the like.

The controller 50 has a computer configuration including a central processing unit (CPU) 501, a read only memory (ROM) 502, and a random access memory (RAM) 503. The CPU 501, the ROM 502, and the RAM 503 are connected to each other via the bus 59.

The CPU 501 controls the operation of the entire POS terminal 5. The ROM 502 stores various programs such as a program to be used for driving the CPU 501 and various types of data. The RAM 503 is used as a work area of the CPU 501. The CPU 501 develops the various programs and the various types of data stored in the ROM 502 or the storage device 51 into the RAM 503. The controller 50 executes various types of control processing of the POS terminal 5 when the CPU 501 operates according to the control program that is stored in the ROM 502 or the storage device 51 and developed into the RAM 503.

Further, the RAM 503 includes a product information unit 5031. The product information unit 5031 stores product information (a product code, a product name, a price, and the like) of the product identified by the product code read by the scanner 54. When the product information is registered (stored) in the product information unit 5031, the product registration is executed.

The storage device 51 includes a storage medium such as a hard disk drive (HDD) and a flash memory, and retains the stored content even when power is cut off. The storage device 51 stores a control program 511, a product master 512, and a deposit/granted point setting table 513.

The control program 511 is, for example, a program for realizing a function of performing product registration on the basis of the product code read by the scanner 54, a function of performing account processing on the basis of the product information registered in the product information unit 5031, a function of transmitting/receiving various types of information to/from the server apparatus 6, a function of setting a point to be given to a customer in one transaction, and the like.

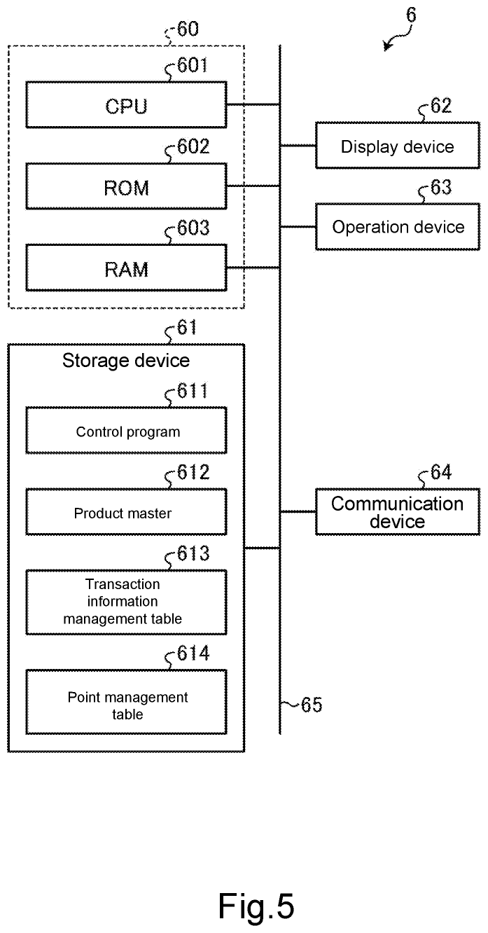

The product master 512 is received from the server apparatus 6. The product master 512 is a master file storing product information such as a product code, a product name, and a price of a product sold in a store. The POS terminal 5 receives the product master 512 from the server apparatus 6 at, for example, a fixed time before opening every day and updates the received product master 512. Note that the storage device 51 does not necessarily need to store the product master 512. In this case, the POS terminal 5 is capable of performing a function similar to that of the configuration storing the product master 512, by communicating with the server apparatus 6 and referring to a product master 612 (see FIG. 5) stored in the server apparatus 6.

The deposit/granted point setting table 513 is a table setting a deposit/granted point to be given for the charge amount that the customer does not receive in cash. The deposit/granted point setting table 513 may be arbitrarily set by the store. FIG. 3 is a diagram showing a data configuration of the deposit/granted point setting table 513. The deposit/granted point setting table 513 stores a change amount and a deposit/granted point in association with each other.

The change amount is information indicating the amount of change generated in one transaction. The deposit/granted point is information indicating the deposit/granted point determined in accordance with the change amount. For example, in the case where a member customer does not receive a change amount of 1 yen or more and less than 250 yen in cash, in other words, the member customer leaves the change amount of 1 yen or more and less than 250 yen at the store, 1 point of a deposit/granted point is given to the member customer.

Referring to FIG. 2 again, a hardware configuration of the POS terminal 5 will be described.

The display device 52 includes a liquid crystal display or the like. The display device 52 displays various types of information under the control of the controller 50. For example, the display device 52 displays product information of a product that has been registered, the total amount (transaction amount) in one transaction, and the like. Further, the display device 52 displays a point to be given to the customer in one transaction, and the like.

The operation device 53 is an input device and is, for example, a touch panel provided on the surface of the display device 52 or a keyboard provided separately from the display device 52. The operation device 53 inputs various types of information input by an operation of a user who uses the POS terminal 5 to the controller 50. For example, the operation device 53 inputs, to the controller 50, information indicating that the customer leaves the change of coins less than 1000 yen.

The scanner 54 reads a product code from a code symbol (hereinafter, referred to also as a “product barcode”) such as a barcode indicating a product code attached to a product. Specifically, the scanner 54 optically recognizes the product barcode or images and recognizes the product barcode. The scanner 54 then decodes the recognized product barcode and reads the product code indicated by the product barcode. Note that the decoding of the product barcode recognized by the scanner 54 may be performed by the controller 50. Further, the scanner 54 reads, from the barcode displayed on the customer terminal 3, a member ID of a store member and a member ID of an electronic receipt service. The scanner 54 may be fixedly provided in the POS terminal 5 or may be a handheld one that the user of the POS terminal 5 can hold and operate.

The card reader 55 reads the member ID of the store member from a member card of the customer. Further, the card reader 55 reads customer information necessary for credit card payment from a credit card of the customer. The card reader 55 may be a magnetic card reader that reads information from a magnetic card or may be an IC card reader that reads information from a card with a built-in IC chip.

The change machine 56 receives, when the customer pays for the purchase in cash, banknotes and coins paid by the customer, and pays out the change as necessary. The change machine 56 prohibits, in the case where information indicating that the customer leaves the change of coins less than 1000 yen is input to the operation device 53, to pay out the change of the coins.

The printer 57 prints a receipt when one transaction is finished. The printer 57 prints, under the control of the controller 50, transaction information relating to one transaction and various types of information relating to the point of the customer on the receipt.

The communication device 58 is an interface for communicating with an external device such as the server apparatus 6. The controller 50 is capable of transmitting/receiving information (data) to/from the external device by being connected to external device via the communication device 58.

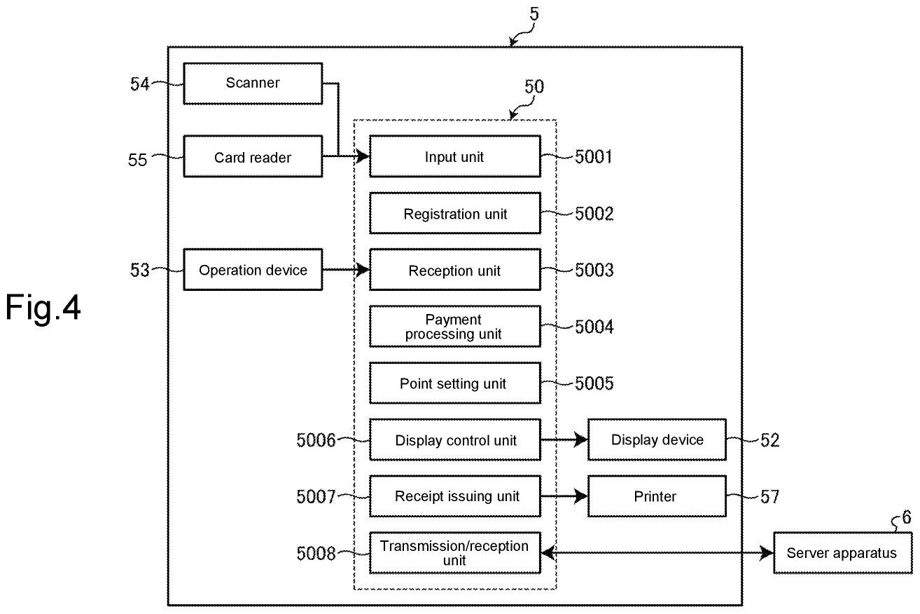

Next, a functional configuration of the controller 50 of the POS terminal 5 will be described. FIG. 4 is a block diagram showing a main functional configuration of the controller 50 of the POS terminal 5. The controller 50 functions, when the CPU 501 operates in accordance with the control program stored in the ROM 502 or the storage device 51, as an input unit 5001, a registration unit 5002, a reception unit 5003, a payment processing unit 5004, a point setting unit 5005, a display control unit 5006, a receipt issuing unit 5007, and a transmission/reception unit 5008. Note that these functions may be realized using hardware such as a dedicated circuit.

Various types of information are input from the scanner 54 and the card reader 55 to the input unit 5001. For example, a member ID of a store member and a member ID of a member of an electronic receipt service are input from the scanner 54 or the card reader 55 to the input unit 5001. Further, a product code is input from the scanner 54 to the input unit 5001.

The registration unit 5002 executes product registration. Specifically, the registration unit 5002 reads, from the product master 512, the product information corresponding to the product code input to the input unit 5001 and registers the read product information in the product information unit 5031 of the RAM 503.

The reception unit 5003 receives various types of information input to the operation device 53. For example, the reception unit 5003 receives information indicating that the customer leaves the change of coins less than 1000 yen at the store in one transaction.

The payment processing unit 5004 executes payment processing relating to one transaction. The payment processing is processing for the customer to complete payment for purchase. The payment processing unit 5004 calculates the transaction amount on the basis of the information registered in the product information unit 5031 of the RAM 503 and executes processing for completing cash payment, credit card payment, or the like. The payment processing unit 5004 calculates the change amount in the case where the customer performs cash payment. The payment processing unit 5004 calculates the change amount by subtracting the transaction amount from the amount of money deposited to the change machine 56.

The point setting unit 5005 sets various points to be given to the customer in one transaction. Specifically, the point setting unit 5005 calculates and sets a normal point on the basis of the transaction amount in one transaction. For example, the point setting unit 5005 calculates the number of points of one percent of the transaction amount calculated by the payment processing unit 5004 and sets the calculated point as the normal point.

Further, the point setting unit 5005 sets, in the case where the member customer leaves the change of coins less than 1000 yen, a deposit/granted point by referring to the deposit/granted point setting table 513. Specifically, the point setting unit 5005 reads, from the deposit/granted point setting table 513, the deposit/granted point corresponding to the change amount calculated by the payment processing unit 5004 and sets the read point.

The display control unit 5006 displays various types of information on the display device 52. For example, the display control unit 5006 displays, on the display device 52, product information of the product that has been registered and the transaction amount in one transaction. Further, the display control unit 5006 displays, on the display device 52, the point set by the point setting unit 5005.

The receipt issuing unit 5007 generates receipt data, transmits the generated receipt data to the printer 57, and causes the printer 57 to issue a receipt. The receipt issuing unit 5007 generates receipt data indicating transaction information in one transaction, which includes various points set by the point setting unit 5005, and outputs the generated receipt data to the printer 57. The receipt data is data in a data format that can be printed by the printer 57.

The transmission/reception unit 5008 transmits/receives various types of information to/from the server apparatus 6. For example, the transmission/reception unit 5008 transmits, to the server apparatus 6, transaction information in one transaction, which include various points set by the point setting unit 5005. The transmission/reception unit 5008 transmits, in the case where the member customer leaves the change of coins less than 1000 yen at the store, the change amount and information indicating to convert the change amount into a point (hereinafter, both of them will be collectively referred to also as a “conversion change amount”) to the server apparatus 6.

The transmission/reception unit 5008 transmits, in the case where the customer who performs a transaction is a member of an electronic receipt service, the receipt data generated by the receipt issuing unit 5007 to the server apparatus 6. The server apparatus 6 transmits the received receipt data to the electronic receipt server 2. Further, the transmission/reception unit 5008 receives, from the server apparatus 6, held points (the total point of a normal point, a deposit/granted point, and a conversion point) currently held by the member customer who performs a transaction.

Note that the transmission/reception unit 5008 transmits, when transmitting information to the server apparatus 6, a POS terminal ID for specifying the apparatus itself. As a result, the server apparatus 6 is capable of specifying the POS terminal 5 that is the source of the information and transmitting a response to the received information to the POS terminal 5.

Next, the server apparatus 6 will be described in detail. FIG. 5 is a block diagram showing a main hardware configuration of the server apparatus 6. The server apparatus 6 includes a controller 60, a storage device 61, a display device 62, an operation device 63, and a communication device 64. The controller 60, the storage device 61, the display device 62, the operation device 63, and the communication device 64 are connected to each other via a bus 65 or the like.

The controller 60 has a computer configuration including a CPU 601, a ROM 602, and a RAM 603. The CPU 601, the ROM 602, and the RAM 603 are connected to each other via the bus 65.

The CPU 601 integrally controls the respective units of the server apparatus 6. The ROM 602 stores various programs such as a program used for driving the CPU 601 and various types of data. The RAM 603 is used as a work area of the CPU 601, and the various programs and the various types of data stored in the ROM 602 or the storage device 61 are developed into the RAM 603. The controller 60 executes, when the CPU 601 operates in accordance with the control program that is stored in the ROM 602 or the storage device 61 and developed into the RAM 603, various types of control processing of the server apparatus 6.

The storage device 61 includes a storage medium such as an HDD and a flash memory, and retains the stored content even when power is cut off. The storage device 61 stores a control program 611, the product master 612, a transaction information management table 613, and a point management table 614.

The control program 611 is, for example, a program for realizing a function of acquiring various points and a change amount in one transaction from the POS terminal 5, a function of converting the change amount acquired from the POS terminal 5 into a point, a function managing the various points, and the like.

Since the product master 612 is similar to the product master 512 stored in the POS terminal 5, overlapping description is omitted. Since products handled in a store change daily, the product master 612 is updated as appropriate and transmitted to each POS terminal 5.

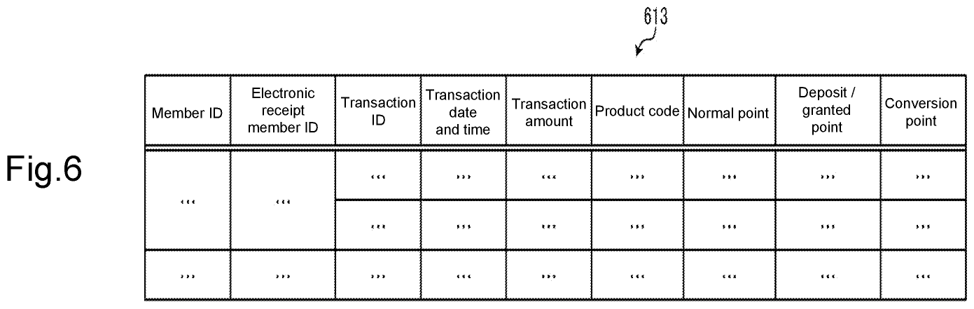

The transaction information management table 613 is a table for managing transaction information in one transaction for each member customer. The transaction information management table 613 is updated on the basis of the information acquired from the POS terminal 5 every time the member customer performs a transaction. Note that a transaction of a customer other than a store member is separately managed by the server apparatus 6. FIG. 6 is a diagram showing a data configuration of the transaction information management table 613. The transaction information management table 613 stores an electronic receipt member ID, a transaction ID, a transaction date and time, a transaction amount, a product code, a normal point, a deposit/granted point, and a conversion point in association with a member ID.

The member ID is information for identifying a store member. The electronic receipt member ID is information for identifying a member of an electronic receipt service. The electronic receipt member ID of only a customer who is a member of an electronic receipt service among store members is registered in association with the member ID.

The transaction ID is information for identifying a transaction. The transaction date and time is information indicating the date and time the account processing was completed by the POS terminal 5 in one transaction. The transaction amount is the amount of money transacted, i.e., the total amount of products purchased by the customer. In the item of the transaction amount, the product price and consumption tax are recognizably registered. The product code is information for identifying a product. In the case where a plurality of products has been purchased in one transaction, a plurality of product codes is registered in the item of the product code.

The normal point is a normal point given to the customer in one transaction. The deposit/granted point is a point given to the customer in one transaction. The conversion point is a point given to the customer in one transaction. The conversion point is a point obtained by converting the change amount received from the POS terminal 5 by the controller 60.

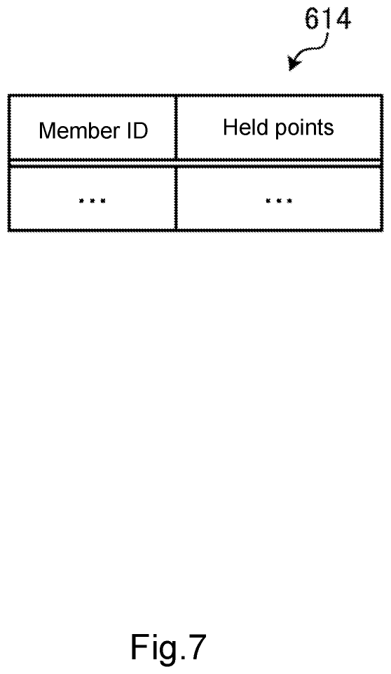

The point management table 614 is a table for managing held points obtained by adding up various points held by the member customer for each member customer. The point management table 614 is updated when the member customer has purchased a product using the point or the member customer has purchased a product and various points are given to him/her. FIG. 7 is a diagram showing a data configuration of the point management table 614. The point management table 614 stores the member ID and the held points in association with each other.

As described above, the member ID is information for identifying a store member. The held points are points currently held by the customer identified by the member ID and are the total points of the normal point, the deposit/granted point, and the conversion point.

With reference to FIG. 5 again, a hardware configuration of the server apparatus 6 will be described.

The display device 62 includes a liquid crystal display or the like. The display device 62 displays various types of information under the control of the controller 60. For example, the display device 62 displays an input screen for inputting information to the product master 612.

The operation device 63 is an input device and includes a touch panel provided on the surface of the display device 62, a mouse, and the like. the operation device 63 inputs, to the controller 60, information input by an operation of a user who operates the server apparatus 6.

The communication device 64 is an interface for communicating with an external device such as the electronic receipt server 2 and the POS terminal 5. The controller 60 is capable of transmitting/receiving information (data) to/from the external device by being connected to the external device via the communication device 64.

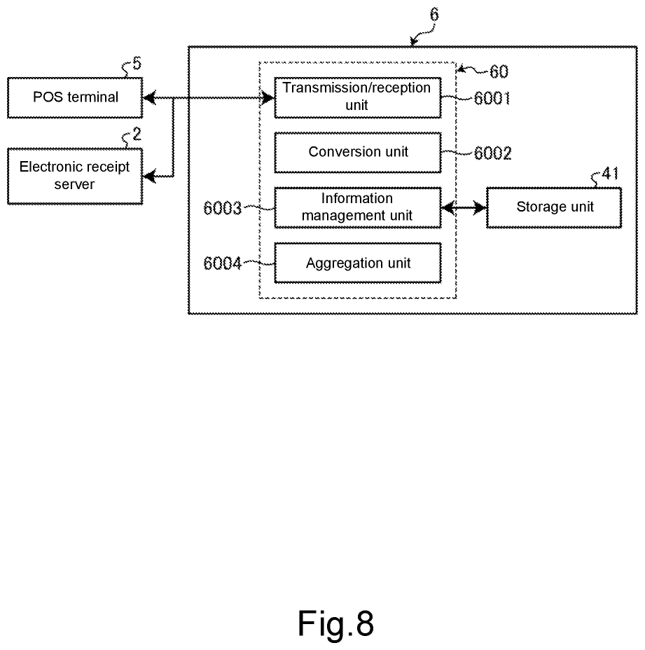

Next, a functional configuration of the controller 60 of the server apparatus 6 will be described. FIG. 8 is a block diagram showing a main functional configuration of the controller 60 of the server apparatus 6. The controller 60 functions, when the CPU 601 operates in accordance with the control program stored in the ROM 602 or the storage device 61, as a transmission/reception unit 6001, a conversion unit 6002, an information management unit 6003, and an aggregation unit 6004. Note that these functions may be realized by hardware such as a dedicated circuit.

The transmission/reception unit 6001 transmits/receives various types information to/from the electronic receipt server 2 and the POS terminal 5. For example, the transmission/reception unit 6001 receives transaction information relating to one transaction from the POS terminal 5. The transaction information includes the normal point and the deposit/granted point set by the POS terminal 5 in one transaction. The transmission/reception unit 6001 functions as a point acquisition unit that acquires a point having monetary value, the point being given to the customer who has purchased a product in one transaction.

Further, the transmission/reception unit 6001 receives, from the POS terminal 5, the conversion change amount in a transaction in which the member customer leaves the change of coins less than 1000 yen without receiving the change in cash. The transmission/reception unit 6001 functions as a change amount acquisition unit that acquires the change amount generated in one transaction.

Further, the transmission/reception unit 6001 transmits the accumulated points aggregated by the aggregation unit 6004 to the electronic receipt server 2 and the POS terminal 5. The accumulated points are the sum of the deposit/granted point earned by one customer in a predetermined period. The transmission/reception unit 6001 functions as an output unit that outputs the accumulated points aggregated by the aggregation unit 6004.

The conversion unit 6002 converts the conversion change amount acquired by the change amount acquisition unit (transmission/reception unit 6001) into a point. Specifically, the conversion unit 6002 converts the conversion change amount received by the transmission/reception unit 6001 into a point having the same monetary value as the conversion change amount. As described above, since it is determined that one point has monetary value of one yen in this embodiment, for example, in the case where the conversion change amount received by the transmission/reception unit 6001 is 100 yen, the conversion unit 6002 converts the conversion change amount into 100 points.

The information management unit 6003 manages various types of information. Managing information unit storing information in a storage device 41 or reading the information from the storage device 41. For example, the information management unit 6003 reads information from the transaction information management table 613 or the point management table 614 as necessary. The information management unit 6003 calculates held points currently held by one member and updates the point management table 614.

The information management unit 6003 stores, in the transaction information management table 613, the normal point and the deposit/granted point received by the transmission/reception unit 6001. Further, the information management unit 6003 stores, in the transaction information management table 613, the conversion point converted by the conversion unit 6002. The information management unit 6003 functions as a point management unit that adds up the point acquired by the transmission/reception unit 6001 and the point converted by the conversion unit 6002 and manages the obtained point for each customer.

The aggregation unit 6004 aggregates the accumulated points of the deposit/granted point for each customer. For example, the aggregation unit 6004 aggregates, when the transmission/reception unit 6001 receives a request for the accumulated points from the electronic receipt server 2, the deposit/granted point of the member ID included in the request for the accumulated points. In detail, the aggregation unit 6004 extracts the past deposit/granted point of the corresponding member ID from the transaction information management table 613 and aggregates (adds) the extracted point. The aggregation unit 6004 may aggregate all the past deposit points of the corresponding member ID or may aggregate the points in a predetermined period, e.g., most recent month.

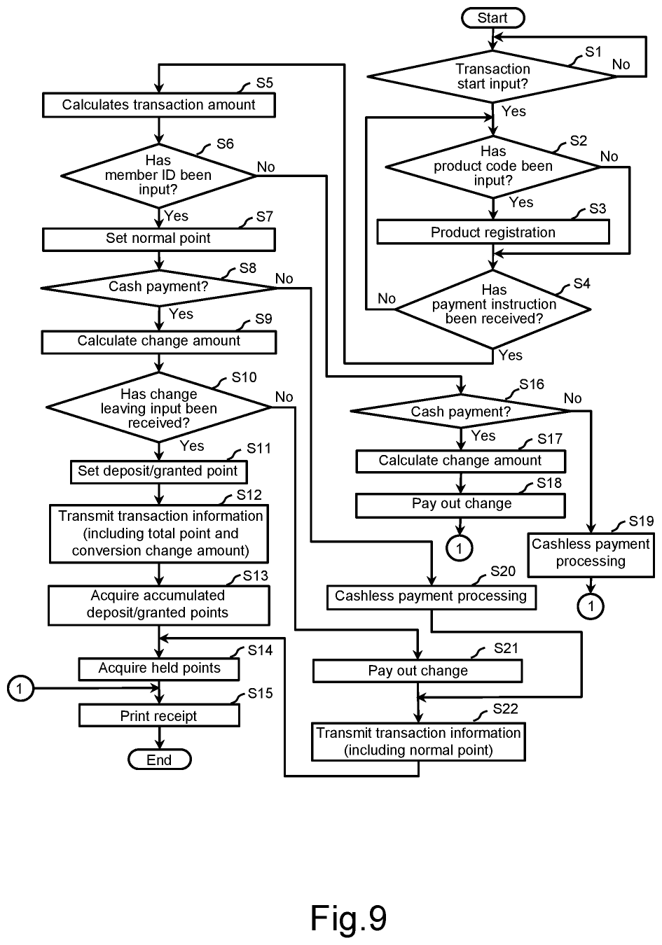

Next, account processing to be executed by the POS terminal 5 having the above configuration will be described. FIG. 9 is a flowchart showing account processing to be executed by the controller 50 of the POS terminal 5. The account processing is executed when a customer pays for the products to be purchased.

In Step S1, the controller 50 determines whether or not a transaction start input has been received from the operation device 53 by the reception unit 5003. In the case where it is determined that no transaction start input has been received (No in Step S1), the processing of the controller 50 returns to Step S1 and stands by. In the case where it is determined that a transaction start input has been received from the operation device 53 by the reception unit 5003 (Yes in Step S1), the processing of the controller 50 proceeds to Step S2. In Step S2, the controller 50 determines whether or not a product code has been input from the scanner 54 to the input unit 5001.

In the case where it is determined that a product code has been input from the scanner 54 to the input unit 5001 (Yes in Step S2), the processing of the controller 50 proceeds to Step S3. In Step S3, the controller 50 performs product registration as the registration unit 5002. Subsequently, in Step S4, the controller 50 determines whether or not a payment instruction has been received from the operation device 53 by the reception unit 5003. In the case where it is determined that no payment instruction has been received (No in Step S4), the processing of the controller 50 returns to Step S2. In the case where it is determined that a product code has not been input from the scanner 54 to the input unit 5001 (No in Step S2), the processing of the controller 50 skips Step S3 and proceeds to Step S4.

In the case where it is determined that a payment instruction has been received from the operation device 53 by the reception unit 5003 (Yes in Step S4), the processing of the controller 50 proceeds to Step S5. In Step S5, the controller 50 serves as the payment processing unit 5004 to calculate the transaction amount. Specifically, the controller 50 serves as the payment processing unit 5004 to calculate the total price of the products and consumption tax registered in the product information unit 5031 of the RAM 503. Subsequently, in Step S6, the controller 50 determines whether or not a member ID of a store member has been input from the card reader 55 to the input unit 5001. The controller 50 determines whether or not a member ID of a store member has been input from the card reader 55 to the input unit 5001 after the transaction start input is made.

In the case where it is determined that a member ID of a store member has been input from the card reader 55 to the input unit 5001 (Yes in Step S6), the processing of the controller 50 proceeds to Step S7. In Step S7, the controller 50 serves as the point setting unit 5005 to set the normal point. Specifically, the controller 50 serves as the point setting unit 5005 to calculate the number of points of one percent of the transaction amount and set the calculated point as the normal point. Note that the transaction amount to be calculated for the normal point may include consumption tax or does not need to necessarily need to include consumption tax.

Subsequently, in Step S8, the controller 50 determines whether or not information indicating that the customer performs cash payment has been received from the operation device 53 by the reception unit 5003. Note that in the case where information indicating that the customer uses held points has been received at this time from the operation device 53 by the reception unit 5003, the controller 50 serves as the transmission/reception unit 5008 to acquire the held points of the customer from the server apparatus 6. The controller 50 then serves as the payment processing unit 5004 to subtract the point to be used by the customer, of the held points, from the transaction amount. In the following description, the amount of money obtained by subtracting the point to be used by the customer from the transaction amount will also be referred to the transaction amount.

In the case where it is determined that information indicating that the customer performs cash payment has been received from the operation device 53 by the reception unit 5003 (Yes in Step S8), the processing of the controller 50 proceeds to Step S9. In Step S9, the controller 50 serves as the payment processing unit 5004 to calculate the change amount. The controller 50 serves as the payment processing unit 5004 to calculate the change amount by subtracting the transaction amount from the amount of money deposited to the change machine 56.

Subsequently, in Step S10, the controller 50 determines whether or not a change leaving input indicating that the customer leaves the change without receiving the change in cash has been received from the operation device 53 by the reception unit 5003. In the case where it is determined that the change leaving input has been received from the operation device 53 by the reception unit 5003 (Yes in Step S10), the processing of the controller 50 proceeds to Step S11. In Step S11, the controller 50 serves as the point setting unit 5005 to set the deposit/granted point. Specifically, the controller 50 serves as the point setting unit 5005 to refer to the deposit/granted point setting table 513 and read, from the deposit/granted point setting table 513, the deposit/granted point corresponding to the change amount generated in the transaction.

Subsequently, in Step S12, the controller 50 serves as the transmission/reception unit 5008 to transmit the transaction information to the server apparatus 6. The transaction information includes the normal point, the deposit/granted point, and the total point of the normal point and the deposit/granted point set by the point setting unit 5005, and the change amount (conversion change amount) calculated by the payment processing unit 5004. Note that the point setting unit 5005 may convert the conversion change amount into a point. In this case, the total point is a point added with also the conversion point converted by the point setting unit 5005.

Subsequently, in Step S13, the controller 50 serves as the transmission/reception unit 5008 to acquire the accumulated deposit/granted points from the server apparatus 6. The accumulated deposit/granted points are accumulated points obtained by adding up the deposit/granted point of the customer registered in the transaction information management table 613 and the set deposit/granted point by the server apparatus 6. For example, the controller 50 serves as the transmission/reception unit 5008 to transmit a request for the accumulated deposit/granted points together with the transaction information to the server apparatus 6. The controller 50 then receives the accumulated deposit/granted points transmitted by the server apparatus 6 in response to the request for the accumulated deposit/granted points. Note that the transmission/reception unit 5008 may receive the accumulated deposit/granted points automatically transmitted by the server apparatus 6 in response to the reception of the transaction information.

In Step S14, the controller 50 serves as the transmission/reception unit 5008 to acquire, from the server apparatus 6, the held points currently held by the customer who has performed the transaction. Subsequently, in Step S15, the controller 50 serves as the receipt issuing unit 5007 to cause the printer 57 to print a receipt. At this time, in the case where the customer is a member of an electronic receipt service, the controller 50 serves as the receipt issuing unit 5007 to output an instruction to issue an electronic receipt to the electronic receipt server 2 via the transmission/reception unit 5008. The controller 50 then finishes the account processing.

Note that in the case where it is determined in Step S6 that no member ID has been input from the card reader 55 to the input unit 5001 (No in Step S6), i.e., the customer is not a store member, the processing of the controller 50 proceeds to Step S16. In Step S16, the controller 50 determines whether or not information indicating that the customer performs cash payment has been received from the operation device 53 by the reception unit 5003.

In the case where it is determined that information indicating that the customer performs cash payment has been received from the operation device 53 by the reception unit 5003 (Yes in Step S16), the processing of the controller 50 proceeds to Step S17. In Step S17, the controller 50 serves as the payment processing unit 5004 to calculate the change amount similarly to Step S9. In Step S18, the controller 50 serves as the payment processing unit 5004 to output, to the change machine 56, an instruction to pay out the calculate change amount. The processing of the controller 50 then proceeds to Step S15.

Further, in the case where it is determined in Step S16 that information indicating that the customer performs cash payment has not been received from the operation device 53 by the reception unit 5003 (No in Step S16), the processing of the controller 50 proceeds to Step S19. In Step S19, the controller 50 serves as the payment processing unit 5004 to execute cashless payment processing. The controller 50 performs, as the cashless payment processing, processing for completing the payment using a payment method such as credit card payment, electronic money payment, and two-dimensional code payment. The controller 50 serves as the payment processing unit 5004 performs, for example, communication with a payment server (not shown) that performs various types of payment to complete the payment using the payment method desired by the customer. The processing of the controller 50 then proceeds to Step S15.

Further, in the case where it is determined in Step S8 that information indicating that the customer performs cash payment has not been received from the operation device 53 by the reception unit 5003 (No in Step S8), the processing of the controller 50 proceeds to Step S20. In Step S20, the controller 50 serves as the payment processing unit 5004 to execute cashless payment processing similarly to Step S19. The processing of the controller 50 then proceeds to Step S22.

Further, in the case where it is determined in Step S10 that no change leaving input has been received from the operation device 53 by the reception unit 5003 (No in Step S10), the processing of the controller 50 proceeds to Step S21. In Step S21, the controller 50 serves as the payment processing unit 5004 to output, to the change machine 56, an instruct to pay out the calculated change amount. In Step S22, the controller 50 serves as the transmission/reception unit 5008 to transmit the transaction information to the server apparatus 6. The transaction information includes the normal point set by the point setting unit 5005. The processing of the controller 50 then proceeds to Step S14.

With the account processing, the POS terminal 5 is capable of completing the payment relating to the transaction and setting the point to be given to the customer.

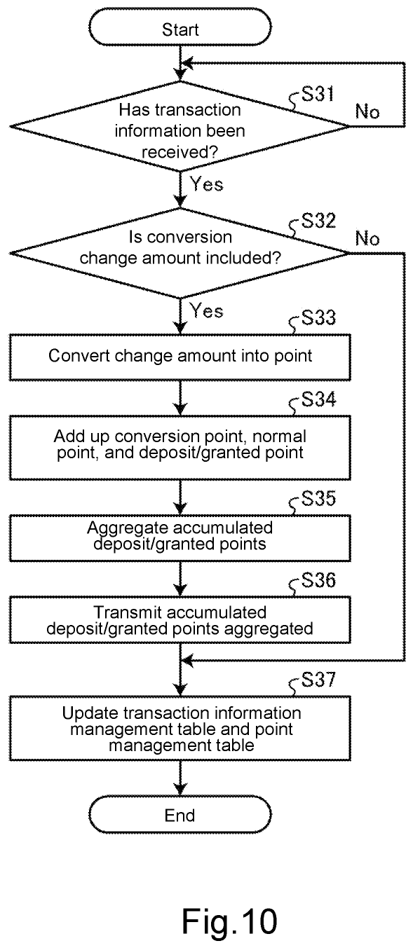

Next, point management processing to be executed by the server apparatus 6 will be described. FIG. 10 is a flowchart showing the point management processing to be performed by the controller 60 of the server apparatus 6. The point management processing is processing of managing the point of the customer on the basis of the transaction information received from the POS terminal 5.

In Step S31, the controller 60 determines whether or not transaction information has been received from the POS terminal 5 by the transmission/reception unit 6001. In the case where it is determined that no transaction information has been received by the transmission/reception unit 6001 (No in Step S31), the processing of the controller 60 returns to Step S31 and stands by. In the case where it is determined that transaction information has been received from the POS terminal 5 by the transmission/reception unit 6001 (Yes in Step S31), the processing of the controller 60 proceeds to Step S32. In Step S32, the controller 60 serves as the conversion unit 6002 to determine whether or not the transaction information received from the transmission/reception unit 6001 includes the conversion change amount.

In the case where it is determined that the transaction information received by the transmission/reception unit 6001 includes the conversion change amount (Yes in Step S32), the processing of the controller 60 proceeds to Step S33. In Step S33, the controller 60 serves as the conversion unit 6002 to convert the change amount into a conversion point. In Step S34, the controller 60 serves as the aggregation unit 6004 to add up the conversion point converted by the conversion unit 6002 and the normal point and deposit/granted point included in the transaction information received by the transmission/reception unit 6001.

Further, in Step S35, the controller 60 serves as the aggregation unit 6004 to aggregate the accumulated deposit/granted points. Specifically, the controller 60 serves as the aggregation unit 6004 to add up the deposit/granted point of the customer registered in the transaction information management table 613 and the deposit/granted point received from the POS terminal 5 by the transmission/reception unit 6001.

In Step S36, the controller 60 serves as the transmission/reception unit 6001 to transmit the accumulated deposit/granted points aggregated by the aggregation unit 6004 to the POS terminal 5. As a result, the POS terminal 5 is capable of showing the accumulated deposit/granted points on the receipt to be issued. For this reason, the store is capable of promoting the benefits of converting the change amount into the point to the customer.

Subsequently, in Step S37, the controller 60 serves as the information management unit 6003 to update the transaction information management table 613 and the point management table 614 on the basis of the transaction information received by the transmission/reception unit 6001. In detail, the controller 60 serves as the information management unit 6003 to additionally register, in the transaction information management table 613, the transaction information received by the transmission/reception unit 6001 and the conversion point converted by the conversion unit 6002. Further, the controller 60 serves as the information management unit 6003 to add the point added up by the processing of Step S34 to the held points of the customer and update the point management table 614. The controller 60 then finishes the point management processing.

Note that in the case where it is determined in Step S32 that the transaction information received by the transmission/reception unit 6001 does not include the conversion change amount (No in Step S32), the processing of the controller 60 skips Step S33 to Step S36 and proceeds to Step S37. In this case, in Step S37, the controller 60 updates only data relating to the normal point received by the transmission/reception unit 6001.

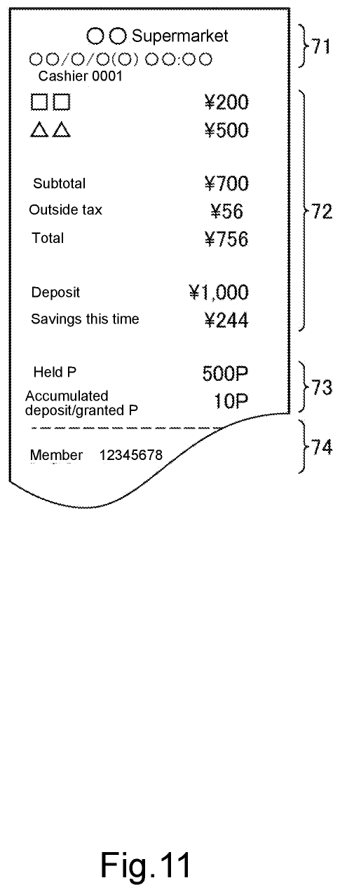

Next, a receipt to be issued by the account processing of the POS terminal 5 will be described. FIG. 11 is a diagram showing a paper receipt to be issued by the POS terminal 5. The paper receipt includes a header portion 71, a purchase information portion 72, a point information portion 73, and a member information portion 74.

In the head portion 71, a store name, a transaction date and time, a number of the POS terminal 5 that has executed account processing, and the like are printed. In the purchase information portion 72, the product name and price of the product purchased by the customer, the subtotal, the tax amount, the total amount, the deposit amount deposited from the customer, the change amount to be converted into a point (savings this time), and the like are printed.

In the point information portion 73, the held points at the time point after the transaction, the accumulated deposit/granted points given so far, and the like are printed. In the member information portion 74, the member ID of the store member is printed. Note that the electronic receipt displayed on the customer terminal 3 displays information similar to the information to be printed on the paper receipt.

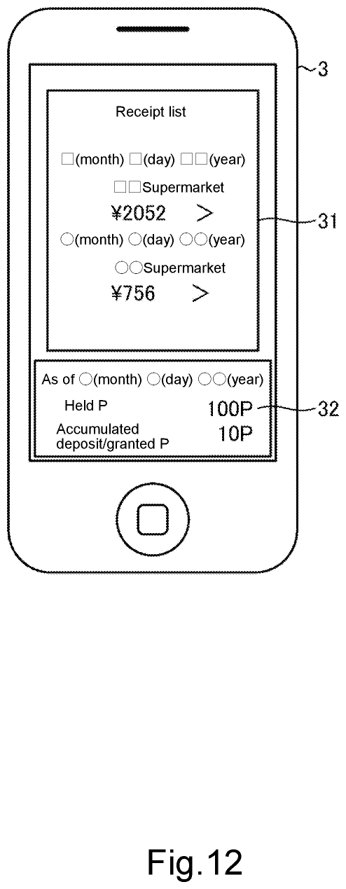

FIG. 12 is a diagram showing a receipt list screen displayed on the customer terminal 3. The receipt list screen displays the information transmitted by the electronic receipt server 2 to the customer terminal 3 in accordance with a request for a receipt list from the customer terminal 3. The receipt list screen includes a receipt information portion 31 and a point information portion 32.

In the receipt information portion 31, the list of receipt information in a predetermined period is displayed. The receipt information includes a transaction date and time, a store name, and a transaction amount. All pieces of receipt information in the predetermined period can be displayed by scrolling in the up-and-down direction in the receipt information portion 31. In the point information portion 32, information similar to that in the point information portion 73 of the paper receipt, i.e., the held points at the time point after the transaction, the accumulated deposit/granted points given so far, and the like are displayed.

By showing the accumulated deposit points on the paper receipt issued by the POS terminal 5 and the electronic receipt and receipt list information issued by the electronic receipt server 2, the customer can recognize the benefits obtained by changing the change amount into a point.

As described above, the controller 60 of the server apparatus 6 according to an embodiment executes the function of the point acquisition unit (transmission/reception unit 6001) that acquires a point having monetary value, the point being given to a customer who has purchased a product in one transaction, the function of the change amount acquisition unit (transmission/reception unit 6001) that acquires a change amount generated in the one transaction, the function of the conversion unit 6002 that converts the change amount acquired by the change amount acquisition unit into the point, and the function of the point management unit (information management unit 6003) that adds up the point acquired by the point acquisition unit and the point converted by the conversion unit 6002 and manages the obtained point for each customer.

As a result, the server apparatus 6 is capable of managing, as a point, the change amount that the customer has not received in cash. For this reason, the server apparatus 6 is capable of collectively managing the change amount and other points that the store gives to the customer and making the operation of the store relating to the change and point generated in a transaction easier.

Further, in the information processing apparatus including the POS terminal 5 and the server apparatus 6 according to an embodiment, the controller 50 of the POS terminal 5 executes the function of the point setting unit 5005 that sets a point to be given to a customer in one transaction.

As a result, the information processing apparatus is capable of easily setting various points such as a normal point, a deposit/granted point, and a conversion point.

Further, in the information processing apparatus including the POS terminal 5 and the server apparatus 6 according to an embodiment, the controller 50 of the POS terminal 5 serves as the point setting unit 5005 to set a deposit/granted point to be given to a customer in the case where the customer does not receive a change amount in cash and converts the change amount into a point.

As a result, the information processing apparatus is capable of promoting the customer to convert the change amount into the conversion point. For this reason, the information processing apparatus is capable of retaining the customer by the store.

In addition, in the information processing apparatus including the POS terminal 5 and the server apparatus 6 according to an embodiment, the controller 50 of the POS terminal 5 serves as the point setting unit 5005 to set a deposit/granted point in accordance with the change amount to be converted into a point.

As a result, the information processing apparatus is capable of increasing the change amount to be converted into a conversion point by a customer. For this reason, the information processing apparatus is capable of more promoting the retaining of the customer by the store.

Further, in the information processing apparatus including the POS terminal 5 and the server apparatus 6 according to an embodiment, the controller 60 of the server apparatus 6 executes the function of the aggregation unit 6004 that aggregates the accumulated points of a deposit/granted point for each customer and the function of the output unit (transmission/reception unit 6001) that outputs the accumulated points aggregated by the aggregation unit 6004.

As a result, the information processing apparatus is capable of promoting the benefits obtained by converting the change amount into the conversion point to the customer. For this reason, the information processing apparatus is capable of more promoting the conversion of the change amount into the conversion point by the customer.

Note that in the embodiment described above, the control program to be executed in each apparatus such as the POS terminal 5 and the server apparatus 6 may be recorded in a recording medium that can be read by a computer, such as a CD-ROM, and provided. Further, the control program to be executed in each apparatus according to the embodiment described above may be stored in a computer connected to a network such as the Internet and provided by being downloaded via the network. Further, the control program may be provided via the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that manages, on a basis of transaction information regarding a transaction with a customer, a point that has monetary value and is given to a customer who has purchased a product in one transaction, comprising:
a point management table that stores, for each piece of identification data of a customer, held points obtained by aggregating the point given to the customer; and
a controller configured to
acquire, for each transaction, transaction information including the identification data of the customer and a change amount and the point generated in the one transaction,
acquire a conversion point obtained by converting the change amount included in the acquired transaction information into the point having the same monetary value as the change amount,
add up the point included in the acquired transaction information and the acquired conversion point, and
update the held points stored in the point management table by adding the added-up points to the held points corresponding to the identification data of the customer included in the acquired transaction information.

2. The information processing apparatus according to claim 1, wherein
the controller is further configured to set a point to be given to the customer in the one transaction.

3. The information processing apparatus according to claim 1, wherein
the controller is further configured to
convert, where the customer does not receive the change amount in cash, the change amount into the conversion point having the same monetary value as the change amount, and
set, where the change amount is converted into the conversion point having the same monetary value as the change amount, a deposit/granted point to be given to the customer.

4. The information processing apparatus according to claim 3, wherein
the controller is further configured to set the deposit/granted point in accordance with the change amount to be converted into the conversion point.

5. The information processing apparatus according to claim 4, further comprising
a deposit/granted point setting table that stores the deposit/granted point corresponding to the change amount,
the controller being further configured to read the deposit/granted point corresponding to the change amount from the deposit/granted point setting table and set the deposit/granted point.

6. The information processing apparatus according to claim 4, wherein
the controller is further configured to
aggregate accumulated deposit/granted points for each customer, and
output the accumulated deposit/granted points thus aggregated.

7. The information processing apparatus according to claim 6, further comprising
a transaction information management table that stores the deposit/granted point for each piece of identification data of a customer,
the controller being further configured to
acquire the transaction information including the set deposit/granted point, and
update the transaction information management table by additionally storing the set deposit/granted point included in the acquired transaction information in association with the identification data of the customer included in the acquired transaction information.

8. The information processing apparatus according to claim 6, wherein
the controller is further configured to aggregate the accumulated deposit/granted points by adding up the deposit/granted point of the customer stored in the transaction information management table and the deposit/granted point included in the acquired transaction information.

9. An information processing apparatus that manages, on a basis of transaction information regarding a transaction with a customer, a point that has monetary value and is given to a customer who has purchased a product in one transaction, comprising:
a payment terminal that executes account processing relating to payment for products to be purchased by a customer; and
a server apparatus that acquires, from the payment terminal, the transaction information including product information of a product paid for in account processing and payment information relating to a payment method, wherein
the payment terminal includes
a deposit/granted point setting table that stores a deposit/granted point corresponding to a change amount generated in the one transaction, the deposit/granted point being given to the customer where the customer does not receive the change amount in cash to promote the customer to leave the change amount, and
a first controller configured to
calculate the change amount in the one transaction,
set, where the customer does not receive the calculated change amount in cash, the deposit/granted point by reading the deposit/granted point corresponding to the calculated change amount from the deposit/granted point setting table, and
causing the transaction information to include identification data of the customer, the calculated change amount, and the set deposit/granted point, and wherein
the server apparatus includes
a point management table that stores, for each piece of identification data of a customer, held points obtained by aggregating the point given to the customer, and
a second controller configured to
acquire, for each transaction, the transaction information from the payment terminal,
acquire a conversion point obtained by converting the change amount included in the acquired transaction information into the point having the same monetary value as the change amount,
add up the deposit/granted point included in the acquired transaction information and the acquired conversion point, and
update the held points stored in the point management table by adding the added-up points to the held points corresponding to the identification data of the customer included in the acquired transaction information.

10. An information processing method for an information processing apparatus that manages, on a basis of transaction information regarding a transaction with a customer, a point that has monetary value and is given to a customer who has purchased a product in one transaction, comprising:
storing, for each piece of identification data of a customer, held points obtained by aggregating the point given to the customer in a point management table;
acquiring, for each transaction, identification data of the customer and transaction information including a change amount generated in the one transaction and the point;
acquiring a conversion point obtained by converting the change amount included in the acquired transaction information into the point having the same monetary value as the change amount;
adding up the point included in the acquired transaction information and the acquired conversion point; and
updating the held points stored in the point management table by adding the added-up points to the held points corresponding to the identification data of the customer included in the acquired transaction information.
